(19) United States
(12) Patent Application Publication
(10) Pub. No.: US 2016/0106626 A1
(43) Pub. Date: Apr. 21, 2016

(54) MEDICATION DOSAGE INDICATOR

(71) Applicant: Janssen Pharmaceutica NV, Beerse (BE)

(72) Inventors: Veronica Barajas, San Diego, CA (US); David Tripi, Goleta, CA (US)

(21) Appl. No.: 14/885,300

(22) Filed: Oct. 16, 2015

Related U.S. Application Data
(60) Provisional application No. 62/065,453, filed on Oct. 17, 2014.

(51) Int. Cl. A61J 7/04; A61J 1/03

(52) U.S. Cl. CPC A61J 7/04; A61J 1/03; A61J 2205/50

(57) ABSTRACT

Dosage log apparatuses, containers and medication dosage recording methodologies for tracking medications and dosage schedules.

### CROSS REFERENCE TO RELATED APPLICATIONS

This application claims the benefit of U.S. Provisional Application 62/065,453, filed on Oct. 17, 2014, which is incorporated herein by reference in its entirety.

### FIELD OF THE INVENTION

Embodiments described herein relate to devices for tracking medications and dosage schedules. In particular, some embodiments relate to a medication container having a dosage schedule indicator.

### BACKGROUND OF THE INVENTION

Medications, both prescription and over-the-counter (OTC), are generally administered at a prescribed dosing interval. For instance, a recommended dosage schedule for acetaminophen may be four hours. Other medications might have a recommended dosage schedule of every six hours. Compliance with the prescribed dosing interval can be extremely important as compliance may reduce the likelihood of a patient overdosing, under-dosing, and may improve treatment outcomes. Following a prescribed dosing interval may be particularly important when a child, infant, or otherwise medically vulnerable patient is receiving treatment.

Nevertheless, patients have difficulty adhering to dosing schedules. For example, a patient might forget the time of a previous dosage, which calls into question whether a current administration of a medication is due in accordance with a specific dosing schedule or interval. This difficulty may worsen when a dosing schedule is relatively long, irregular, includes dosing during the night, is relatively short, or is otherwise difficult to follow.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

Example embodiments will be described and explained with additional specificity and detail through the use of the accompanying drawings in which:

FIGS. 1A and 1B illustrate an example dosage log apparatus;

FIGS. 2A-2K illustrate example embodiments of the dosage log apparatus;

FIGS. 3A-3C and 4 illustrate an example method of recording a dosage of a medication using the dosage log apparatus of FIG. 2H; and

FIGS. 5A, 5B, and 6 illustrate an example method of recording a dosage of a medication using the dosage log apparatus of FIG. 2A.

### DETAILED DESCRIPTION OF SOME EXAMPLE EMBODIMENTS

Conveniently and accurately recording medication dosage times may assist a patient in adhering to an optimum dosing schedule for the medication. Adhering to the dosing interval may reduce the likelihood that the patient overdoses (or under doses). For example, overdosing on acetaminophen may cause liver damage or even death. Some patients keep track of the time a medication is taken by relying on memory, or by writing the time down on a document or a pill container. Such approaches are unreliable under the best of circumstances, and are especially unreliable in the context of medications that affect memory, or with patients that may other cognitive decline. Similarly, written reminders may become cluttered, confusing, illegible and/or misplaced. Such reminders can also be ineffective if separated from the medication container, or worse, are mistakenly associated with another medication or container.

Accordingly, some embodiments described herein relate to an intuitive dosage indicator that is associated with a medication container and that enables the patient to record an administration time of a medication and more generally to adhere to a dosing interval of a medication.

An example embodiment includes numbers representative of those on a standard clock face (e.g., 1, 2 . . . 12 or 24) provided on a neck of a medication container (such as a bottle) and associated with a cap having a corresponding indicator. The cap and the indicator is moved, rotated, or otherwise manipulated, to any of the numbers to indicate and record a time of an administered dose of the medication. Alternatively, the numbers may be on the cap and the indicator may be on the neck of the pill bottle. When a medication is administered, the patient or another individual (e.g., a parent or health care provider) rotates the cap such that the indicator aligns with the number of the current time, thus recording the approximate time of the “last” dose taken. In some embodiments, the numbers and/or the indicator may be inscribed, printed or otherwise reproduced on a rubber band or adhesive sticker. For example, a sticker may be adhered around a neck of a medication bottle, or a rubber band may be stretched and placed around the neck of the medication bottle. This approach allows retrofit of an existing prescription bottle or over-the-counter (OTC) bottle with the appropriate numbers and/or indicator.

Reference is made to the drawings to describe various aspects and examples of some representative embodiments. It is to be understood that the drawings are diagrammatic and schematic representations of the embodiments, and are not meant to be limiting, nor are they necessarily drawn to scale. Throughout the appended drawings, like numbers generally reference like structures unless described otherwise.

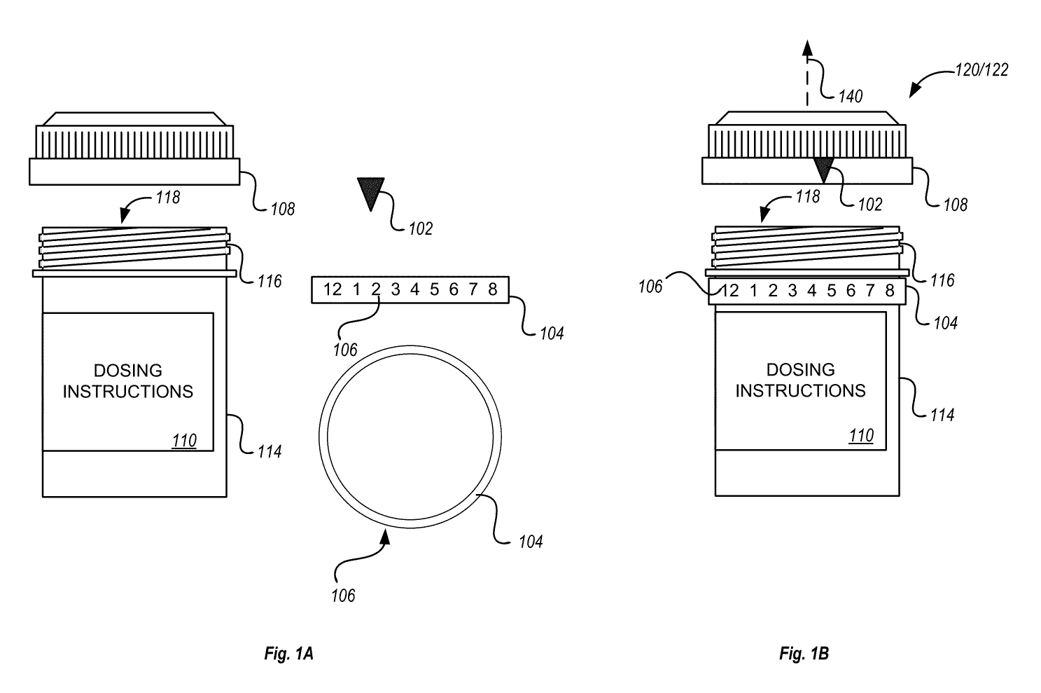

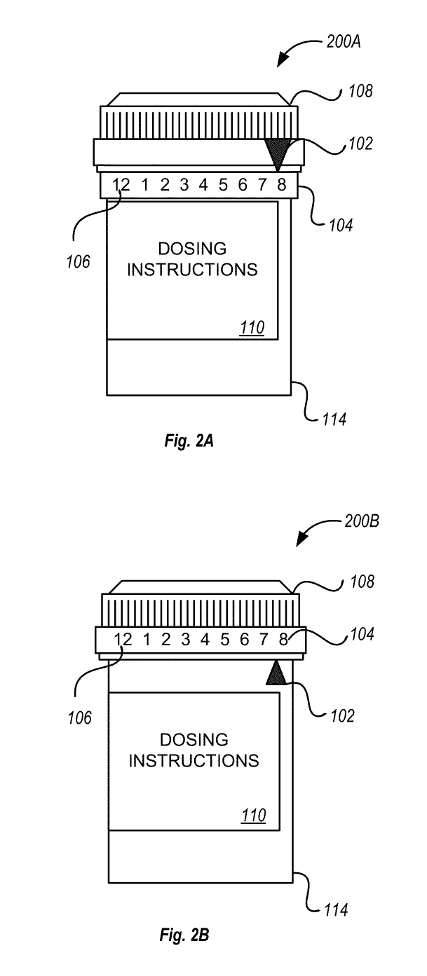

FIGS. 1A and 1B illustrate an example dosage log apparatus (apparatus) 122 that may be installed on an example medication container 120. FIG. 1A depicts the apparatus 122 separate from the medication container 120. Additionally, FIG. 1A depicts two views of a band 104 that includes temporal symbols 106 that correspond to, for example, units of time. FIG. 1B depicts one example of the apparatus 122 installed on the medication container 120.

The medication container 120 generally can be in the form of any medication container that is configured to store a medication. Some examples of the medication container 120 include a prescription medication container distributed by a pharmacy, a personal medication container, an OTC medication container, and the like. In the illustrated example, the medication container 120 of FIGS. 1A and 1B includes a cap 108 and a bottle 114. The bottle 114 defines an opening 118 at a first end 116. The opening 118 defines one end of a volume defined within the bottle 114. Of course, other types of containers might also be used.

The cap 108 is selectively secured to the bottle 114. For example, in the illustrated embodiment, the bottle 114 and the cap 108 each define complementary threads, and the cap 108 can be secured to the bottle 114 via rotation of the cap and/or the bottle.

In the example shown, the bottle 114 includes dosing instructions, denoted at 110. The dosing instructions 110 might form a portion of a label that is adhered to the bottle 114. The dosing instructions 110 may include a dosing interval such as “take two pills every four hours.” In some embodiments, the dosing instructions 110 may not be associated with the bottle 114.

The apparatus 122 includes the band 104 and a temporal indicator (indicator) 102. The band 104 includes the temporal symbols 106. The temporal symbols 106 can be disposed on the band 104 by printing, inscription or any other suitable approach. Generally, the temporal symbols 106 are included on an outer surface of the band 104 to be viewable by a patient when the installed on the bottle 114.

In the illustrated embodiment, the temporal symbols 106 of FIGS. 1A and 1B (and elsewhere herein) correspond to hours of a clock. Accordingly, the temporal symbols 106 that can be seen in FIG. 1A include 1, 2, 3, 4, 5, 6, 7, 8, and 12. The temporal symbols 106 “9,” “10,” and “11” are accordingly on a section of the band 104 that is not visible. In other embodiments, the temporal symbols 106 may include numbers from 1 to 24 corresponding to a 24-hour clock. Additionally or alternatively, the temporal symbols may include marks or dashes for 15-minute or 30-minute periods, for instance. Additionally or alternatively, the temporal symbols 106 may include other characters such as “M” for midnight, “N” for noon, or any other character or symbol that may correspond to a unit of time or any other suitable temporal indicator.

The band 104 is substantially circular in FIG. 1A. The shape of the band 104 may be dictated by the peripheral shape of the medication container 120 on which the band 104 is to be positioned. For example, the medication container 120 illustrated here is substantially cylindrical and the band 104 has a corresponding circular shape. In some embodiments, the band 104 may be a rigid ring. The rigid ring may include a diameter that fits on a particular bottle (e.g., the bottle 114). Alternatively, the band 104 may include an elastic band having a circumference substantially corresponding to the bottle 114, the cap 108, or a given range of bottles or caps. For example, in embodiments in which the band 104 is an elastic band, the band 104 may include a diameter that is stretched to conform to a range of bottle (or similar container) sizes. When released, the band 104 is secured to the bottle 114 via elastic force. Additionally or alternatively, the band 104 may include an adhesive and be adhered to the bottle 114 or the cap 108.

In the example embodiment, the indicator 102 of FIGS. 1A and 1B is generally triangular in shape. One of the angles of the indicator 102 may be aligned with one of the temporal symbols 106 of the band 104. The indicator 102 may include an adhesive such that the indicator 102 can be adhered to the bottle 114 or to the cap 108. In some embodiments, the indicator 102 may include another shape that sufficiently conveys or points to one of the temporal symbols 106. In other embodiments, the apparatus 122 may not include the indicator 102. For instance, the cap 108 may include another feature that may be used as the indicator.

Referring to FIG. 1B, one example of the apparatus 122 as it might be installed on the bottle 114 is shown. In the depicted embodiment, when installed, the indicator 102 is adhered to the cap and the band 104 may extend at least partially along a perimeter of the bottle 114 near the first end 116. For example, in the depicted embodiment, the band 104 is installed below the threads that secure the cap 108 to the bottle 114. In this location, when the cap 108 is secured to the bottle 114, the indicator 102 is aligned with the temporal symbols 106.

In some embodiments, the band 104 or the indicator 102 may be omitted. For example, the temporal symbols 106 may be printed or inscribed on the bottle 114 and/or the cap 108. Similarly, the indicator 102 may be printed or inscribed on the bottle 114. As discussed more below, an object or feature included on the cap 108 or the bottle 114 may be used to perform one or more of the functions of the indicator 102.

In the illustrated example, to record a dose time, the cap 108 is rotated about a longitudinal axis 140. As the cap 108 is rotated, the indicator 102 can be aligned with one of the temporal symbols 106 so as to indicate a time that a dose of a medication is taken. Accordingly, the patient knows when to take a subsequent dose by adding the dosing interval to the indicated temporal symbol 106. Alternatively, the patient can align the indicator 102 with the temporal symbols 106 corresponding to the time the next dose is to be administered according to a prescribed dosing interval.

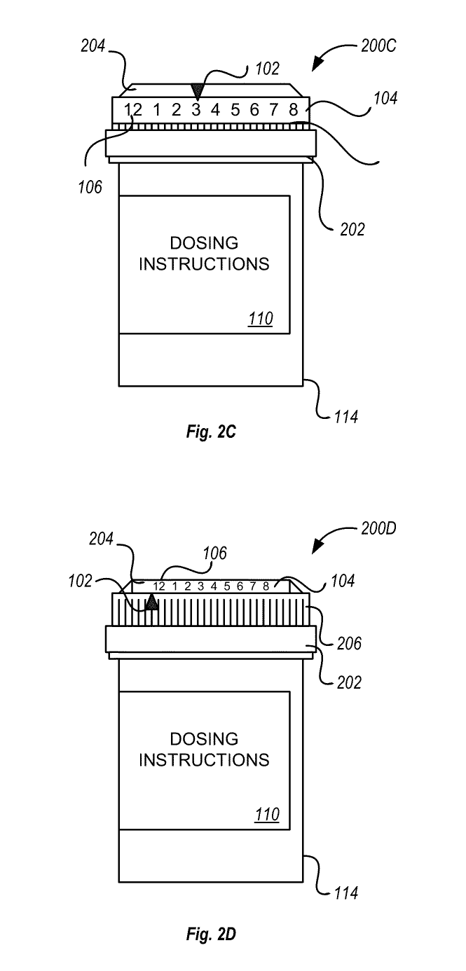

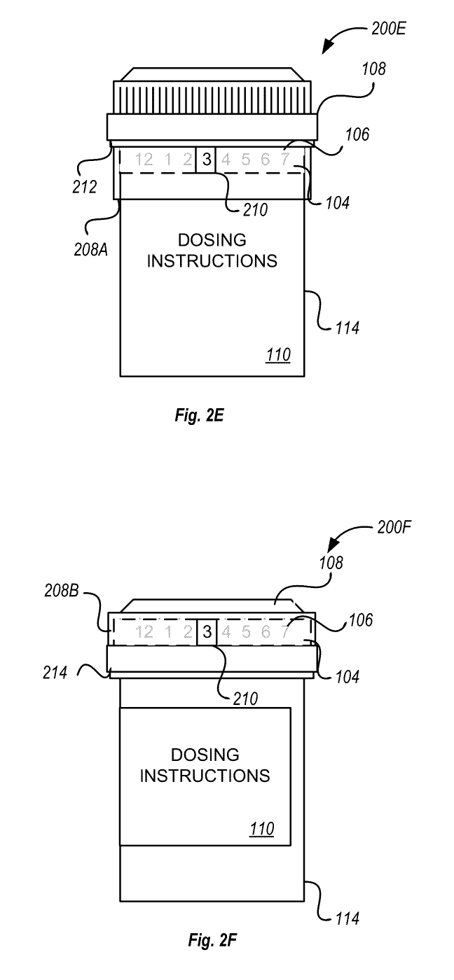

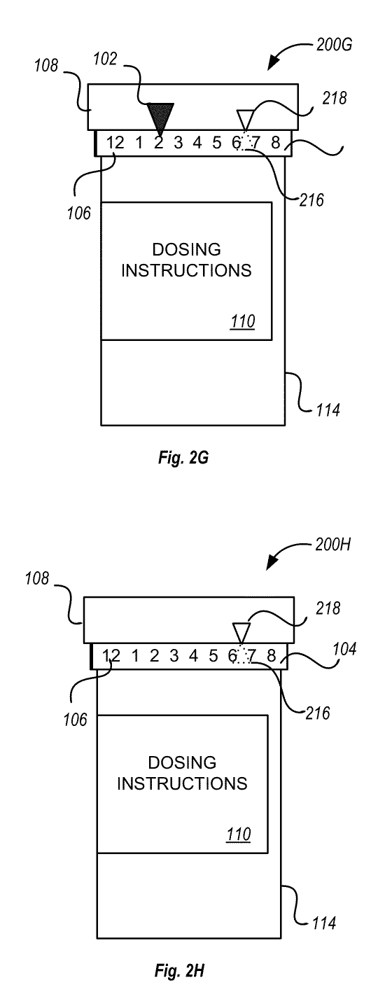

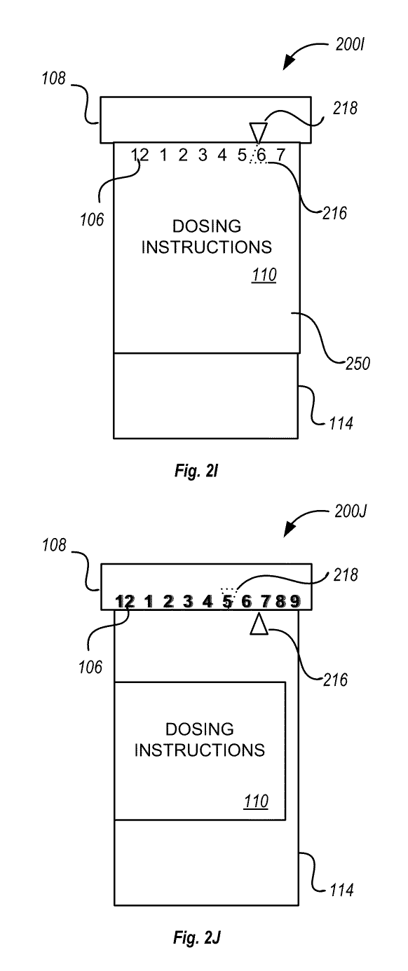

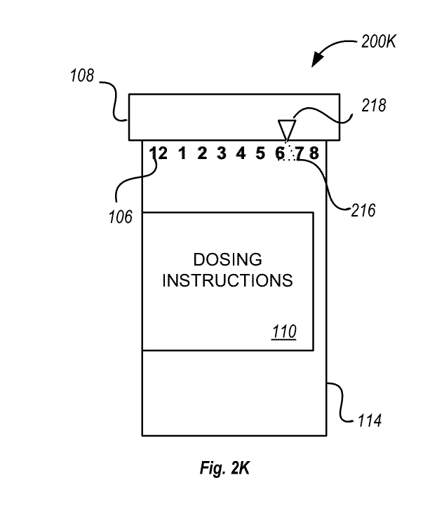

FIGS. 2A-2K illustrate additional embodiments of medication containers having a dosage log apparatus, denoted generally at 200A-200K (generally, log apparatus 200 or log apparatuses 200). Each log apparatus 200 of FIGS. 2A-2K functions in a manner that is similar to the medication container 120 and the apparatus 122 of FIGS. 1A and 1B and accordingly include some components and features already described in connection with Figs. 1A and 1B.

FIG. 2A illustrates a first log apparatus implementation, denoted at 200A. The first log apparatus 200A is similar to the medication container 120 and the apparatus 122 of FIG. 1B. For example, the indicator 102 is included on the cap 108 and the band 104 is installed on the bottle 114. In the first log apparatus 200A, the band 104 and the indicator 102 are permanently included on the bottle 114 and the cap 108, respectively. For example, the patient may purchase medication, which may be included in the container provided by the first log apparatus 200A that includes the indicator 102 and the band 104. As used herein, the term “permanently included” includes a structure in which components are manufactured, otherwise produced, or assembled together. For instance, permanently included components may not be removed and re-used by a consumer, or an intention of a producer is not to have these components reused.

FIG. 2B illustrates yet another log apparatus denoted as 200B. This second log apparatus 200B includes the band 104 on the cap 108 and the indicator 102 on the bottle 114. In some embodiments of the second log apparatus 200B, the indicator 102 and the band 104 are added to the bottle 114 and the cap 108 (e.g., adhered or the band 104 is an elastic band). In other embodiments, the band 104 and the indicator 102 are permanently included on the cap 108 and the bottle 114, respectively. To use the second log apparatus 200B, the patient may rotate the cap 108 with respect to the bottle 114 to align one of the temporal symbols 106 indicating a current time or a time of a subsequent dose with the indicator 102.

FIGS. 2C and 2D illustrate another log apparatus, denoted at 200C and a fourth, denoted at 200D. On each, a multi-component cap 202 is included. The multi-component cap 202 includes a first portion 204 that rotates relative to a second portion 206. In some embodiments, the first portion 204 is a rotatable portion and the second portion 206 is a fixed portion. In other embodiments, the second portion is the rotatable portion and the first portion 204 is the fixed portion.

With reference to FIG. 2C, log apparatus 200C includes the indicator 102 on the first portion 204 and the band 104 on the second portion 206. The first portion 204 may be rotated relative to the second portion 206 to align the indicator 102 with one of the temporal symbols 106 corresponding to a current time or a time of a subsequent dose.

In the depicted log apparatus 200C, the indicator 102 and/or the band 104 may be permanently included on the multi-component cap 202. Alternatively, the band 104 and/or the indicator 102 may be installed on the multi-component cap 202 by the patient or another user in a manner, for example, previously described.

With reference to FIG. 2D, the example log apparatus 200D includes the indicator 102 on the second portion 206 and the band 104 on the first portion 204. The first portion 204 may be rotated relative to the second portion 206 to align the indicator 102 with one of the temporal symbols 106 corresponding to a current time or a time of a subsequent dose.

In the depicted log apparatus 200D, the indicator 102 and/or the band 104 may be permanently included on the multi-component cap 202. Alternatively, the band 104 and/or the indicator 102 may be installed on the multi-component cap 202 by the patient or another user.

FIGS. 2E and 2F illustrate yet additional implementations, which are denoted at 200E and 200F. Each of these embodiments includes a sleeve indicator 208A and 208B respectfully. The sleeve indicators 208A and 208B include a window 210 that is aligned with one of the temporal symbols 106 to indicate a current time or a time of a subsequent dose. The sleeve indicators 208A and 208B are rotated with respect to the band to allow the window 210 to be aligned.

With reference to FIG. 2E, a first sleeve indicator 208A surrounds a portion of the bottle 114. The band 104 may be included between the first sleeve indicator 208A and the portion of the bottle 114 that is surrounded by the first sleeve indicator 208A. Thus, the temporal symbols 106 not aligned with the window 210 are obscured from view.

In some embodiments, the first sleeve indicator 208A may be rotationally attached to the bottle 114. For example, the first sleeve indicator 208A may be rotationally attached to a lip 212 of the bottle 114. In other embodiments, the first sleeve indicator 208A may be rotationally attached to the bottle 114 at another suitable location.

With reference to FIG. 2F, a second sleeve indicator 208B surrounds a portion of the cap 108. The band 104 may be included between the second sleeve indicator 208B and the portion of the cap 108 surrounded by the second sleeve indicator 208B. Thus, the temporal symbols 106 not aligned with the window 210 are obscured from view.

In some embodiments, the second sleeve indicator 208B may be rotationally attached to the cap 108. For example, the second sleeve indicator 208B may be rotationally attached to a cap lip 214 of the cap 108. In other embodiments, the second sleeve indicator 208B may be rotationally attached to the cap 108 at another suitable location.

FIGS. 2G and 2H illustrate yet other additional embodiments as log apparatus 200G and log apparatus 200H. Log apparatus 200G and 200H include the bottle 114 with a first safety feature 216 and the cap 108 with a second safety feature 218. The first safety feature 216 is shown with a dashed line to indicate that the band 104 is on top of the first safety feature 216. To remove the cap 108 from the bottle 114, the first safety feature 216 is aligned with the second safety feature 218.

FIG. 2G illustrates log apparatus 200G. In this example, the apparatus includes the indicator 102 on the cap 108. The indicator 102 is aligned with one of the temporal symbols 106 to indicate a current time or a time of a subsequent dose. As previously discussed in connection with some embodiments, the band 104 and/or the indicator 102 may be installed (e.g., adhered or stretched) on the cap 108 and the bottle 114. Alternatively, the band 104 and/or the indicator 102 may be permanently included on the cap 108 and/or the bottle 114. Additionally or alternatively, in some embodiments, the band 104 may be included on the cap 108 and the indicator 102 may be included on the bottle 114.

With reference to FIG. 2H, the indictor 102 is omitted. In the embodiment denoted at 200G of FIG. 2G, the second safety feature 218 is used to indicate a current time or a time of a subsequent dose. For example, the cap 108 may be secured to the bottle 114 following an administration of a dose of a medication by aligning the first safety feature 216 with the second safety feature 218. The cap 108 may then be rotated to one of the temporal symbols 106 to log the time of the dose or to indicate a time of a subsequent dose. In some embodiments, the band 104 can be included on or installed onto the cap 108, which may surround the second safety feature 218, and the first safety feature 216 may be used as an indicator. As in some previously discussed log apparatuses 200, the band 104 may be installed on (e.g., adhered or stretched and placed) on the cap 108 or the bottle 114. Alternatively, the band 104 may be permanently included on the cap 108 and/or the bottle 114.

Use of the second safety feature 218 or the first safety feature 216 as an indicator represents examples of physical objects that may be used as the indicator. Other features, protrusions, marks, dashes, imprints, symbols, characters, or any other suitable feature on the cap 108 or the bottle 114 may be used as an indicator.

Referring next to FIGS. 2I-2K, embodiments of the log apparatus 200I-200K are depicted in which the band 104 is omitted. In these and other embodiments, the temporal symbols 106 may be included on a label 250 (as depicted in log apparatus 200I), on the bottle 114 (as depicted in log apparatus 200J), or the cap 108 (as depicted in log apparatus 200K).

With particular reference to FIG. 2I, the temporal symbols 106 may be printed on a portion of the label 250. In particular, the temporal symbols 106 may be printed on an upper portion of the label 250 that aligns with a lower portion of the cap 108 when the cap 108 is secured to the bottle 114. The cap 108 may be rotated such that the second safety feature 218 on the cap 108 indicates a current time or a time of a subsequent dose.

For example, the cap 108 may be secured to the bottle 114 following an administration of a dose of a medication by aligning the first safety feature 216 with the second safety feature 218. The cap 108 may then be rotated to one of the temporal symbols 106 printed on the label 250 to log the time of the dose or to indicate a time of a subsequent dose.

In some embodiments, the temporal symbols 106 may also be printed on a label included on the cap 108. In these and other embodiments, the first safety feature 216 may be used as an indicator. In some embodiments, the log apparatus 200I may include an indicator 102. The indicator 102 may be added to the cap 108 or bottle 114 as described above or may be printed on the on the cap 108.

With reference to FIGS. 2J and 2K, the temporal symbols 106 may be embossed onto the cap 108 (as depicted in FIG. 2J) or onto the bottle 114 (as depicted in FIG. 2K). As used herein, embossed temporal symbols 106 may include temporal symbols 106 protruding from or extending into an outer surface of the cap 108 or bottle 114.

In the log apparatus 200J of FIG. 2J in which the temporal symbols 106 are embossed on the cap 108, the first safety feature 216 may be used to indicate a current time or a time of a subsequent dose. For example, the cap 108 may be rotated such that one of the temporal symbols 106 on the cap 108 is aligned with the first safety feature 216 that indicates the current time or the time of a subsequent dose.

In the log apparatus 200K of FIG. 2K in which the temporal symbols 106 are embossed on the bottle 114, the second safety feature 218 may be used to indicate a current time or a time of a subsequent dose. For example, the cap 108 may be rotated such that the second safety feature 218 is aligned with one of the temporal symbols 106 that indicates the current time or the time of a subsequent dose. In some embodiments, the log apparatuses 200J and 200K may include an indicator 102. The indicator 102 may be added to the cap 108 or bottle 114 as described above or may be printed on the on the cap 108.

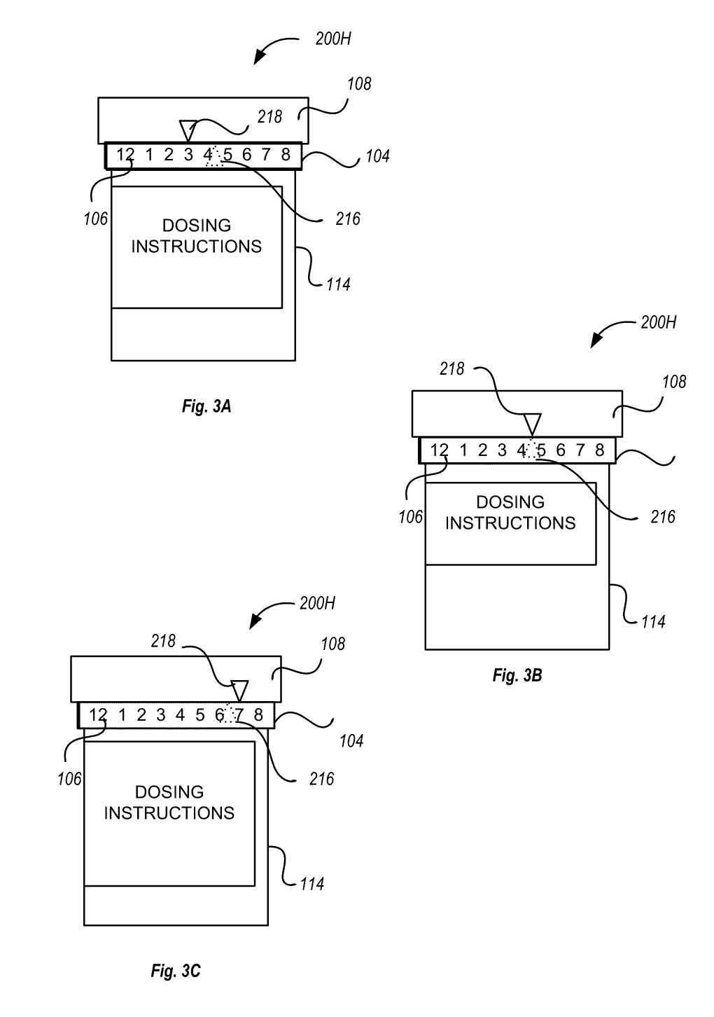

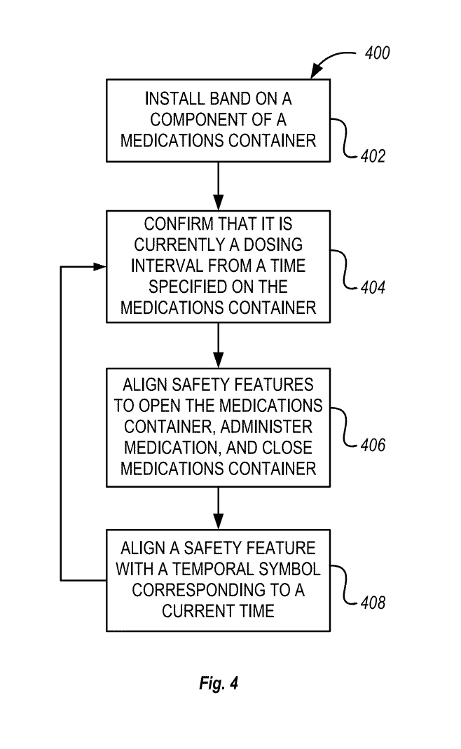

FIGS. 3A-3C and 4 illustrate one example process for recording a dosage of a medication using the dosage log apparatus of the type illustrated in FIG. 2H. While the process, illustrated as a series of steps at method 400, is explained with reference to the log apparatus denoted at 200H, similar methods might be performed with any of the log apparatuses 200 of FIGS. 2A-2G and 2I-2K or the apparatus 122 of FIGS. 1A and 1B. The log apparatus of the sort denoted at 200H does not include the indicator 102; however, it should be understood with the benefit of this disclosure that the method 400 or some variation thereof may be performed with any of the log apparatuses 200 of FIGS. 2A-2G or the apparatus 122 of FIGS. 1A and 1B. Although process steps are illustrated as discrete steps, various steps may be divided into additional steps, combined into fewer steps, or eliminated, depending on the desired implementation.

The method 400 may begin at step 402 where a band may be installed on a component of a medication container. For example, with reference to FIG. 3A, the band 104 may be installed on the bottle 114. In some embodiments, the band 104 may be installed on the cap 108. Additionally in some embodiments, an indicator (e.g., the indicator 102 described herein) may be installed on a component of the medication container.

At step 404, it may be confirmed that it is currently a dosing interval from a time specified on the medication container. For example, with reference to FIG. 3A, a time of 3:00 is specified. The patient or another user may confirm that a current time is a dosing interval from the time specified. For example, if the dosing interval is four hours, the patient may confirm that it is 7:00, which is one dosing interval from the specified time of 3:00.

At step 406, safety features may be aligned to open the medication container, the medication may be administered, and the medication container may then be closed. For example, with reference to FIG. 3B, the second safety feature 218 may be aligned with the first safety feature 216. The patient may then remove the cap 108, administer a medication, and secure the cap 108 to the bottle 114. When the patient secures the cap 108 to the bottle 114, the safety features 216 and 218 may be aligned as depicted, or may not be aligned.

At step 408, a safety feature may be aligned with a temporal symbol corresponding to a current time. For example, with reference to FIG. 3C, the second safety feature 218 may be aligned with the temporal symbol 106 representing a “7,” which indicates that a current time is 7:00. Following step 408, the method 400 may continue to one or more of steps 404, 406, and 408.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For example, in some embodiments, the method 400 may omit step 402.

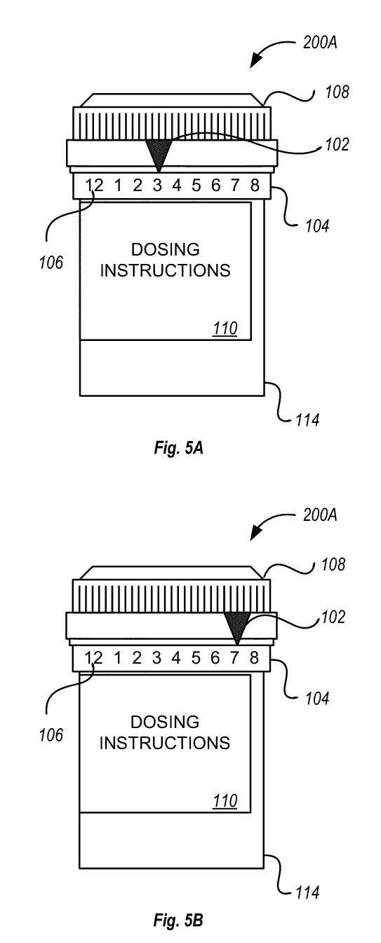

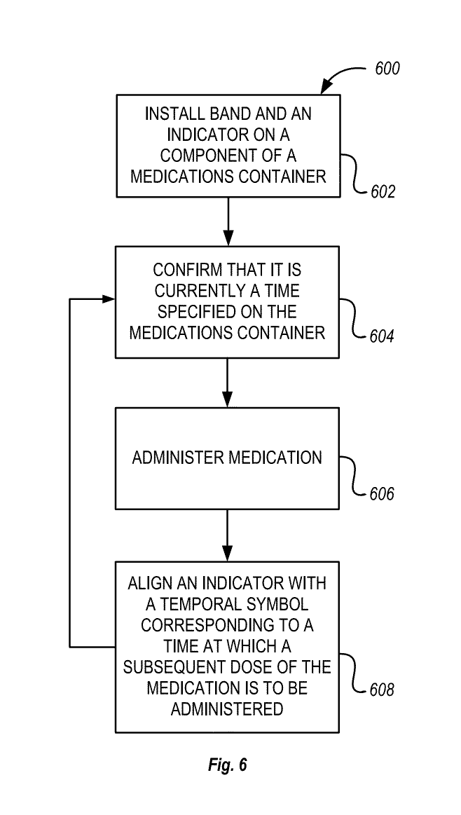

FIGS. 5A, 5B, and 6 illustrate an example method 600 of recording a dosage of a medication using the log apparatus embodiment denoted at 200A of FIG. 2A or the apparatus 122 of FIG. 1B. In particular, FIGS. 5A and 5B depict a sequence of the log apparatus 200A that generally follows the steps of the method 600. The method 600 may be performed by the patient or another individual using the log apparatus 200A, for example. While the method 600 is explained with reference to the log apparatus 200A, similar methods may be performed with any of the log apparatuses 200 of FIGS. 2B-2K or the apparatus 122 of FIG. 1A. The log apparatus 200A includes the indicator 102; however, it should be understood with the benefit of this disclosure that the method 600 or some variation thereof might be performed with the log apparatuses that do or do not include the indicator 102. Although illustrated as discrete steps, various steps may be divided into additional steps, combined into fewer steps, or eliminated, depending on the desired implementation.

The method 600 may begin at step 602. At step 602, a band and an indicator is installed on a component of a medication container. For example, with reference to FIG. 5A, the band 104 may be installed on the bottle 114 and the indicator 102 may be installed on the cap 108. In some embodiments, the band 104 may be installed on the cap 108 and the indicator 102 may be installed on the bottle 114. Additionally in some embodiments, the indicator 102 may be omitted and another object may be used referencing one of the temporal symbols 106.

At step 604, it may be confirmed that it is currently a time specified on the medication container. For example, with reference to FIG. 5A, the indicator 102 is aligned with the temporal symbol 106 “3,” which specifies a time of 3:00. The patient may confirm that a current time is 3:00. At step 606, the patient may administer a medication. For example, the patient may remove the cap 108 from the bottle 114, administer the medication, and replace the cap 108 on the bottle 114.

At step 608, an indicator may be aligned with a temporal symbol corresponding to a time at which a subsequent dose of the medication is to be administered. The subsequent dose of the medication may be due to be administered at one dosing interval from the current time. For example, with reference to FIG. 5B, a dosing interval may be four hours. Accordingly, the patient may align the indicator 102 with the temporal symbol 106 of “7,” which represents 7:00. Following step 608, the method 600 may continue to step 604.

The present invention may be embodied in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A dosage log apparatus comprising:
a container that defines a volume configured to store a medication;
a cap configured to be selectively secured to the container;
one or more temporal symbols; and
a temporal indicator,
wherein the temporal indicator and the one or more temporal symbols are associated with the container or the cap and are configured to be aligned so as to indicate a dosage time.

2. The dosage log apparatus of claim 1, further comprising a band on which the one or more temporal symbols are included.

3. The dosage log apparatus of claim 2, wherein the band is an elastic band that is disposed on the container or the cap.

4. The dosage log apparatus of claim 2, wherein the band includes adhesive that adheres to the container or the cap.

5. The dosage log apparatus of claim 1, wherein:
the one or more temporal symbols are located at least partially along a perimeter of the container;
the temporal indicator is included on the cap; and
the cap is configured to move relative to the container to align the temporal indicator with a temporal symbol.

6. The dosage log apparatus of claim 1, wherein:
the one or more temporal symbols are located at least partially along a perimeter of the cap;
the temporal indicator is included on the container; and
the cap is configured to move relative to the container to align the temporal indicator with one of the temporal symbols.

7. The dosage log apparatus of claim 1, further comprising an indicator sleeve movably attached to the cap or the container, wherein the temporal indicator includes a window defined in the indicator sleeve.

8. The dosage log apparatus of claim 7, wherein:
the one or more temporal symbols are located at least partially along a perimeter of the cap; and
the indicator sleeve is configured to move relative to the cap to align the window with at least one of the temporal symbols.

9. The dosage log apparatus of claim 7, wherein:
the one or more temporal symbols are located at least partially along a perimeter of the container; and
the indicator sleeve is configured to move relative to the cap to align the window with at least one of the temporal symbols.

10. The dosage log apparatus of claim 1, further comprising a band on which the temporal symbols are included, wherein:
the container is substantially cylindrical;
the temporal symbols are positioned circumferentially around the container;
the temporal indicator is positioned on the cap; and
the cap is configured to rotate when selectively secured to the container to allow alignment of the temporal indicator with the temporal symbols.

11. The dose log apparatus of claim 1, wherein:
the cap includes a rotatable portion and a fixed portion; and
the temporal indicator is included on the rotatable portion and the one or more temporal symbols are included on the fixed portion, or
the temporal indicator is included on the fixed portion and the one or more temporal symbols are included on the rotatable portion.

12. A dosage log apparatus configured to be attached to a medication container to record when a dose of a medication is administered, the apparatus comprising:
a band including temporal symbols that correspond to units of time on an external surface of the band; and
a temporal indicator configured to be attached to a portion of the medication container adjacent to the band such that the temporal indicator is alignable with one of the temporal symbols to record a particular time.

13. The apparatus of claim 12, wherein the band includes an elastic band having a circumference corresponding to a body or a cap of the medication container.

14. The apparatus of claim 12, wherein:
the band includes a material with an adhesive surface configured to be adhered to a body or a cap of the medication container; and
the temporal indicator includes a material with an adhesive surface configured to be adhered to the body or the cap.

15. A method of recording a dose of a medication comprising:
confirming that it is currently a dosing interval from a time specified on a medication container;
aligning safety features to open the medication container;
administering a medication;
closing the medication container; and
aligning one of the safety features with a temporal symbol corresponding to a current time.

16. The method of claim 15, further comprising installing a band on a component of the medication container.

17. The method of claim 16, wherein:
the band includes an elastic band; and
the installing includes stretching the elastic band over the component and releasing the elastic band.

18. The method of claim 17, wherein:
the band includes a sticker; and
the installing includes adhering the band to the component of the medication container.

19. A method of recording a dose of a medication comprising:
confirming that it is currently a time specified on a medication container;
administering a medication; and
aligning a temporal indicator with a temporal symbol corresponding to a time at which a subsequent dose of the medication is to be administered.

20. The method of claim 19, further comprising installing a band and/or the temporal indicator on components of the medication container.

21. The method of claim 20, wherein:
the band includes an elastic band; and
the installing includes stretching the elastic band over one of the components and releasing the elastic band.

22. The method of claim 20, wherein:
the band and the temporal indicator include stickers; and
the installing includes adhering the band to one of the components and the temporal indicator to another of the components.

23. A container that defines a volume configured to store a medication, the container comprising:
a bottle in which the volume is at least partially defined, the bottle including a first safety feature;
a cap configured to be releasably secured to the bottle, the cap including a second safety feature; and
temporal symbols corresponding to times of day, the temporal symbols being associated with the bottle or the cap and configured to be aligned with the first safety feature or the second safety feature to indicate a dosage time.

24. The container of claim 23, wherein the temporal symbols are embossed on the cap.

25. The container of claim 23, wherein the temporal symbols are embossed on the bottle.

26. The container of claim 23, wherein the temporal symbols are printed on a label affixed to the bottle.

27. The container of claim 23, wherein the temporal symbols are printed on a label affixed to the cap.
